(19) United States
(12) Patent Application Publication
(10) Pub. No.: US 2003/0133312 A1
(43) Pub. Date: Jul. 17, 2003

(54) Positioning structure for lighting fibers of a decorative lamp

(76) Inventor: Fu-Shien Hsu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/045,141

(22) Filed: Jan. 15, 2002

(51) Int. Cl. G02B 6/00

(52) U.S. Cl. 362/581; 362/568; 362/583; 362/554

(57) ABSTRACT

The present invention relates to a positioning structure for lighting fibers of a decorative lamp, which is composed of a shell, a bulb, a control unit, and a rotated color plate. A transparent plate is provided and fixed in a joint of the shell and placed under the lower end of the lighting fiber for positioning and preventing the lighting fiber from touching the rotated plate.

### BACKGROUND OF THE INVENTION

A conventional decorative lamp with a bench of lighting fibers is composed of a shell (1), a bulb (2), a control unit (3), and a rotated color plate (4). A bench of lighting fiber (5) is received in a sleeve (6), which is connected with a joint (11) of the shell (1). In use, the light emitted from the bulb (2) can pass through the color plate (4) to the lower end of the lighting fiber (5) and emits out from the upper portion of the other end (51) that obtains a colorful decorative effect. Since the bulb (2) will produce heat, some lighting fiber (5) would be possibly moved downward, especially when the top portion is fixed. The lower end of the lighting fiber may touch the rotated color plate (4) that causes bad situation.

Accordingly, the primary object of the invention is to provide a positioning structure for lighting fibers of a decorative lamp to overcome the drawback of the prior art. Now the features and advantages of the present invention will be described in detail with reference to the accompanying drawings.

### BRIEF DESCRIPTION OF ACCOMPANYING DRAWINGS

FIG. 1 is an exploded plan view showing a positioning structure for lighting fibers of a decorative lamp according to the present invention.

FIG. 2 is an assembled plan view of FIG. 1 according to the present invention.

FIG. 3 is an enlarged view showing a part of FIG. 2.

### DETAILED DESCRIPTION OF PREFERRED EMBODIMENTS

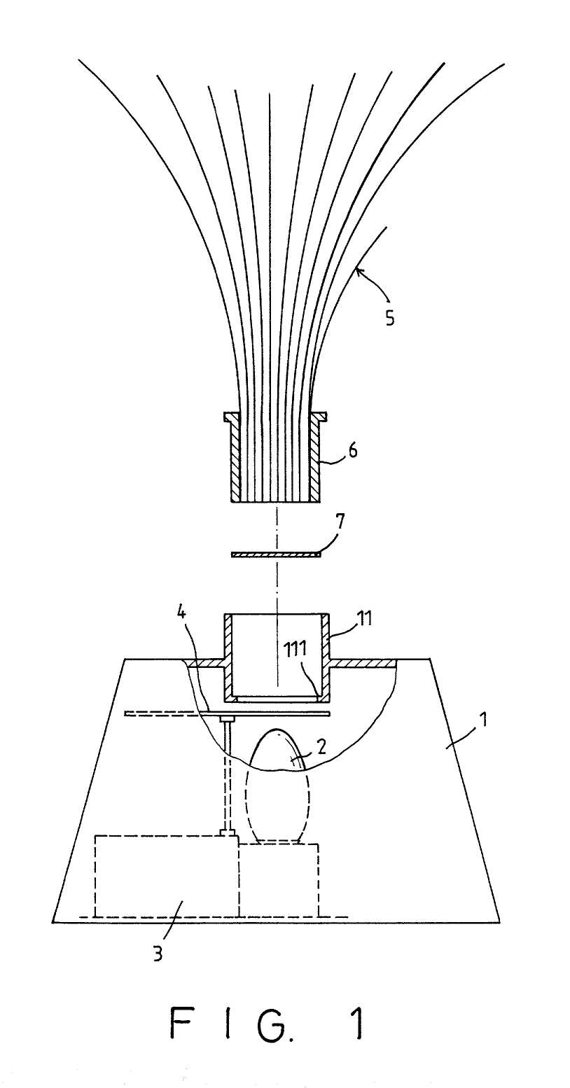

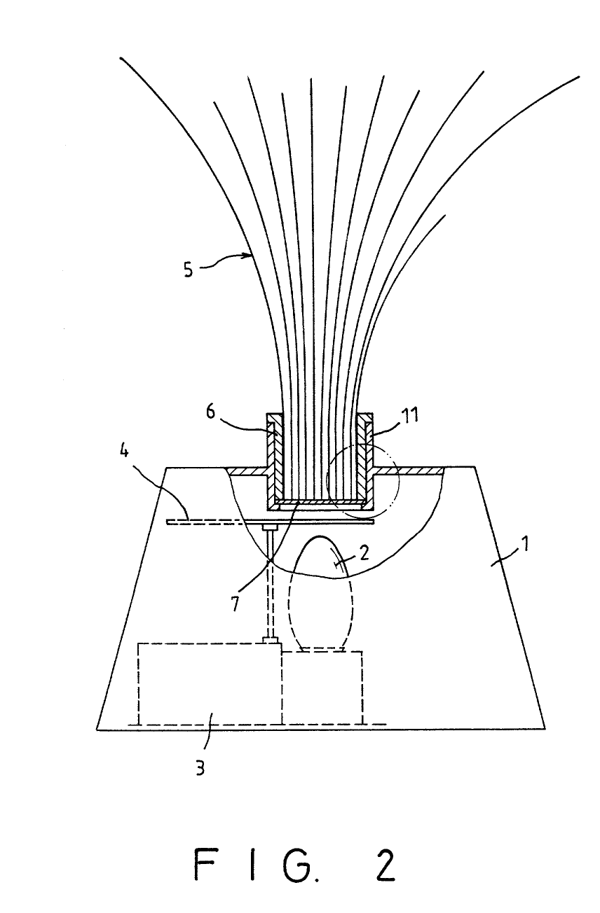

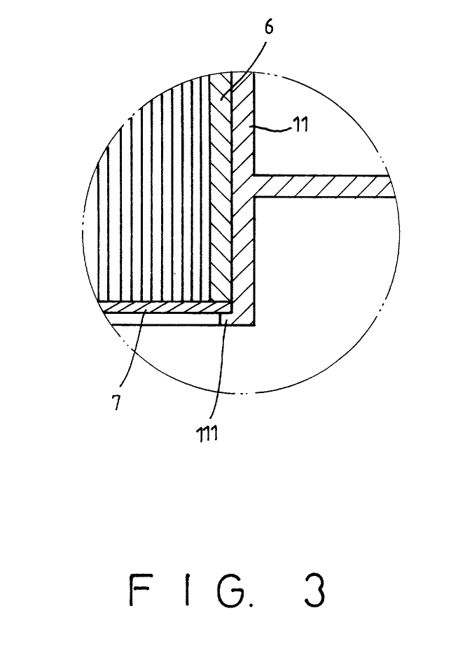

Please refer to FIGS. 1 to 3, the present invention is basically composed of a shell (1), a bulb (2), a control unit (3), and a rotated color plate (4), wherein the shell (1) has a hollow joint (11) at top portion. The joint (11) is provided with a lower inward flange (111). A transparent plate (7) is capable of being placed on the flange (111) in the joint (11). A bench of lighting fiber (5) received in a sleeve (6) is then engaged within the joint (11) of the shell (1). As in use, the lower end of the lighting fiber (5) can be positioned on the transparent plate (7) and will never touch the rotated plate (4) to prevent from any trouble or damage of the lamp.

Nevertheless, the embodiment in this description is only an example that will not be seem to limit the scope of the present invention. It is possible to modify or change a part of the structure based on the invention and that will be also claimed in the present invention.

What is claimed is:

1. A positioning structure for lighting fibers of a decorative lamp being composed of a shell, a bulb, a control unit, and a rotated color plate; the characteristic is that a transparent plate is provided and fixed in a joint of the shell under the lower end of the lighting fiber for positioning and preventing the lighting fiber from touching the rotated plate.

2. The positioning structure for lighting fibers of a decorative lamp as claimed in claim 1, wherein the joint is provided a lower inward flange to position the transparent plate thereon.

3. The positioning structure for lighting fibers of a decorative lamp as claimed in claim 1, wherein the lower end of the lighting fiber is engaged with a positioning transparent plate.

4. The positioning structure for lighting fibers of a decorative lamp as claimed in claim 1, wherein a transparent plate is fixed in the joint of the shell.
